(19) United States
(12) Patent Application Publication
(10) Pub. No.: US 2004/0037670 A1
(43) Pub. Date: Feb. 26, 2004

(54) Securing device for a structural component to be secured to a panel

(75) Inventors: Uwe Rausch, Tambach-Dietharz (DE); Wilfried Pinzl, Tambach-Dietharz (DE)

Correspondence Address: BANNER & WITCOFF, 1001 G STREET N W, SUITE 1100, WASHINGTON, DC, 20001, US

(73) Assignee: EJOT GmbH & Co. KG, Bad Laasphe (DE)

(21) Appl. No.: 10/642,588

(22) Filed: Aug. 19, 2003

(30) Foreign Application Priority Data
Aug. 20, 2002 (DE) 102 38 034.1

(51) Int. Cl. F16B 43/02

(52) U.S. Cl. 411/546

(57) ABSTRACT

The invention relates to a securing device for a structural component to be secured to a panel with a tubular piece inserted into a penetration in the panel, into which tubular piece is inserted a screw, said screw being supported with its head on the one end of the tubular piece and holding the structural component with its threaded part, said structural component contacting the other end of the tubular piece, said tubular piece being screwed an optional distance into the penetration for axial adjustment. The tubular piece contains a distance detector, wherein, when the tubular piece is at a distance from the structural component, said distance detector is in its starting position projecting out of said tubular piece on its side facing away from the screw head and, when the tubular piece is in contact with the structural component, said distance detector is noticeably displaced out of the tubular piece.

The invention relates to a securing device for a structural component to be secured to a panel with a tubular piece inserted into a penetration in the panel, into which tubular piece is inserted a screw, said screw being supported with its head on the one end of the tubular piece and holding the structural component with its threaded part, said structural component contacting the other end of the tubular piece, said tubular piece being screwed an optional distance into the penetration for axial adjustment.

Such a securing device is known from EP 1215404A1. In said securing device, the contacting of the structural component by the relevant end of the tubular piece, as the thus detectable end position of the tubular piece, makes it possible to determine which contact is greater or lesser depending on the force applied when screwing in the tubular piece.

The object of the invention is to design the securing device such that the force of such contact is of no significance with regard to the ending of the screwing-in of the tubular piece into the panel. The object of the invention is achieved in that the tubular piece contains a distance detector, wherein, when the tubular piece is at a distance from the structural component, said distance detector is in its starting position projecting out of said tubular piece on its side facing away from the screw head and, when the tubular piece is in contact with the structural component, said distance detector is noticeably displaced out of the tubular piece.

The distance detector provides the assembler (person or automatic machine) with a detectable signal indicating that the tubular piece is in contact with the structural component, this ruling out the possibility of contact being made with either low or high pressure, which might result, owing to inevitable inner elasticities of the overall arrangement, in differences in the distance between panel and structural component. As soon as the contacting of the tubular part by the tubular piece is detected during the screwing-in of the tubular piece into the panel, this is the signal to stop the screwing-in operation, this meaning that, when using the securing device, irrespective of the existing distance between panel and structural component, there is always the same contact pressure between the tubular piece and the structural component and therefore a defined distance between panel and structural component, this then also being permanently maintained by the securing device provided for this purpose.

The displacement of the distance detector can be detected in a variety of manners. First of all, it is possible for the position of the distance detector in relation to the tubular piece to be made such that any displacement can be detected with the eye, i.e. visually. On the other hand, especially if the tubular piece is screwed in automatically, it is possible to employ a mechanical detector which reacts in known manner to the displacement of the distance detector. From the area of optical measurement, a light barrier may also enter into consideration as the distance detector. Mechanical detection may additionally be accomplished by a known electrically or electromagnetically acting distance sensor and the like.

Advantageously, the distance detector may be in the form of a sleeve inserted into the tubular piece. When in its starting position, on one of its sides the sleeve projects out of the tubular piece and is then displaced into the tubular piece when the tubular piece contacts the structural component. On its other side, the sleeve assumes a position which is detectable either visually or, as described above, in other manner. The sleeve may advantageously be slotted, it being possible to make use of its inherent radial tension in order to hold the sleeve in the tubular piece with a certain friction, so that the sleeve is held in its starting position before the securing device is attached.

A further possible way of holding the distance detector in its starting position consists in forcing the distance detector into its starting position by means of a spring element. From said starting position, the distance detector is then forced back into a backward position against the force of the spring element when contact is made with the structural component, this making it possible for such contacting to be indicated.

The spring element may be implemented in a variety of forms. Advantageously, the spring element consists of oblique surfaces disposed on the sleeve on its side facing away from the screw head, said oblique surfaces cooperating with sloping faces at the relevant end of the tubular piece. On account of said oblique surfaces, the distance detector is given the spring-assisted tendency to project out of the tubular piece and thus to assume its starting position, out of which it is then displaced, against the action of the oblique surfaces and the sloping faces, into the backward position for indicating that the tubular piece has contacted the structural component.

Example embodiments of the invention are shown in the drawings, in which:

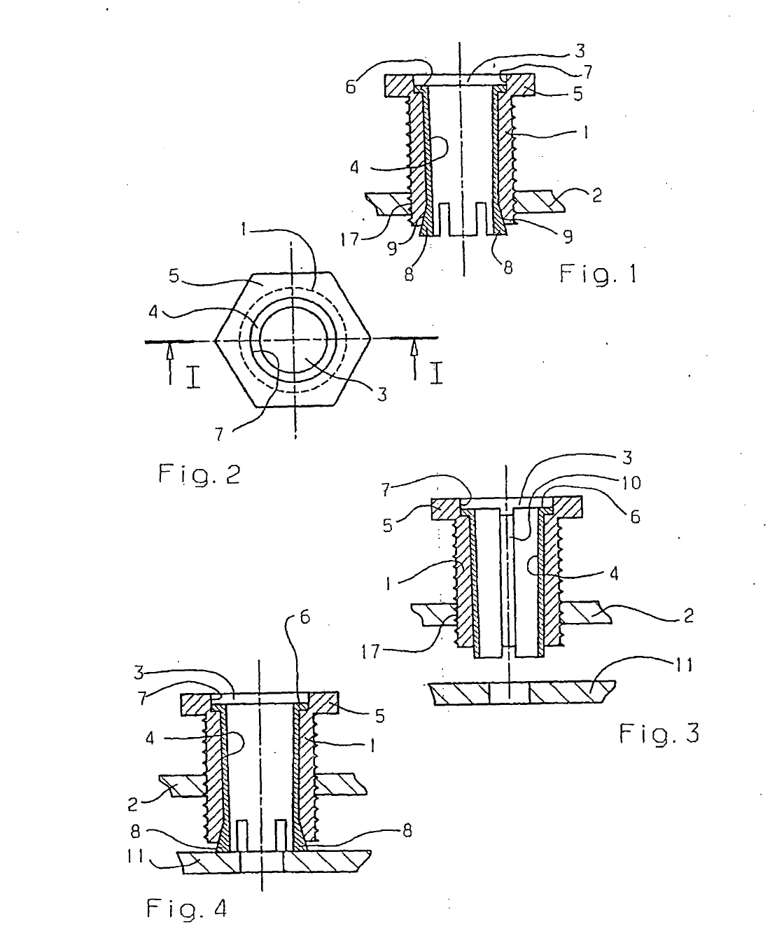

FIG. 1 shows the securing device in a position in which the tubular piece has just been inserted into a panel in which the distance detector, in the form of a sleeve, is in its starting position, this being shown in section along line I-I from FIG. 2;

FIG. 2 shows a top view of the securing device according to FIG. 1;

FIG. 3 shows the securing device similarly to that in FIG. 1 with the tubular piece screwed further into the panel, close to a structural component, with slotted sleeve;

FIG. 4 shows the securing device according to FIG. 1 with the tubular piece screwed in further, said tubular piece being just about to contact the structural component, the sleeve not yet having been displaced;

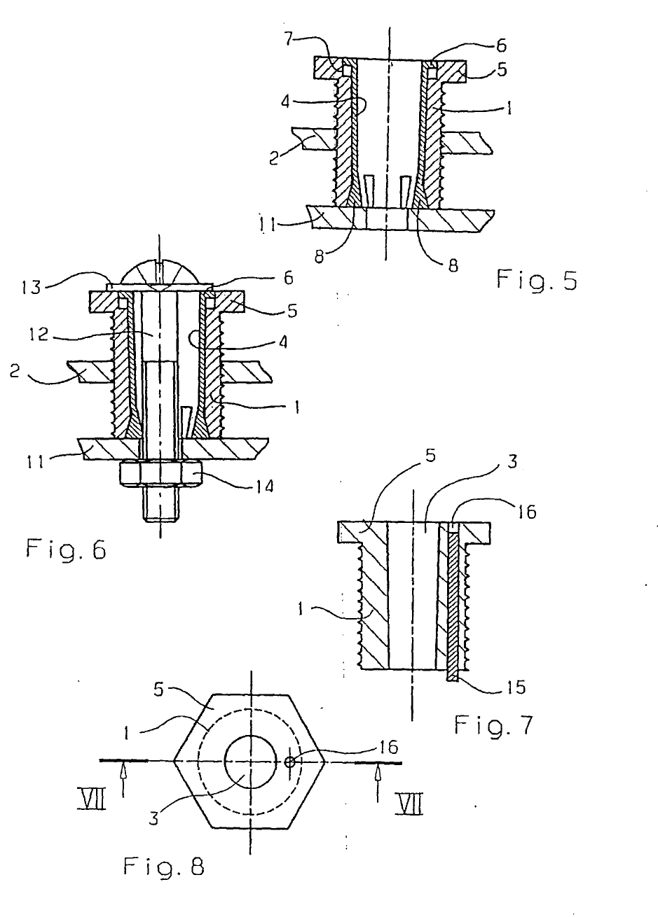

FIG. 5 shows the securing device according to FIG. 4 with the tubular piece in contact with the structural component, the sleeve having been displaced into a clearly visible position with respect to the tubular piece;

FIG. 6 shows the securing device according to FIG. 5 together with a screw with which the securing device is firmly screwed to the structural component;

FIG. 7 shows the securing device with a pin as the distance detector, this being shown in section along line VII-VII from FIG. 8;

FIG. 8 shows a top view of the securing device according to FIG. 7.

FIG. 1 shows the securing device with the tubular piece 1 and the panel 2, this being shown in section along line II-II from FIG. 2, the outside thread of the tubular piece 1 having been screwed into the penetration 17 in the panel 2 as far as its cross section extends. The panel 2 is any structural element, such as a part of the body of a motor vehicle. For this purpose, the thread of the tubular piece 1 is so designed that it is able to cut its own mating thread in the panel 2. However, it is, of course, also possible for the panel 2 to have been previously provided with a corresponding mating thread. Inserted into the through-hole 3 of the tubular piece 1 is the sleeve 4, which is of such a length that it projects out of the panel 2 on the side facing away from the flange 5 of the tubular piece 1. On the side of the flange 5 the sleeve 4 comprises the collar 6, which projects into the widened part 7 of the through-hole 3 and which is positioned at the step at the transition from the widened part 7 to the cylindrical part of the through-hole 3. Consequently, the sleeve 4 has a defined starting position.

In order to secure the starting position of the sleeve 4 as shown in FIG. 1 against inadvertent displacement, the sleeve 4 has, at its end facing away from the collar 6, obliquely extending parts 8, the external oblique surfaces of which are in contact with sloping faces 9 at the relevant end of the tubular piece 1 and thus, in cooperation with said sloping faces 9, provide the sleeve 4 with the tendency to slide out of the tubular piece 1 in the direction away from the flange 5 until the collar 6 contacts the step of the widened part 7 in the above-described manner.

FIG. 2 shows a top view of the securing device according to FIG. 1 with the tubular piece 1 and its flange 5 as well as the sleeve 4.

FIG. 3 shows a securing device which is basically the same as that shown in FIGS. 1 and 2, but in which, in order to secure the sleeve 4 against displacement in the tubular piece 1, the sleeve 4 is provided with the slot 10, the purpose of which is to make use of a radially acting expansion force of the sleeve 4 in order to ensure that the sleeve 4 is held in the tubular piece 1 with a certain friction. Apart from that, the sleeve 4 corresponds to the one shown in FIG. 1, the sleeve 4 likewise being held in the widened part 7 with the collar 6 and projecting out of the tubular piece 1 on its side facing away from the flange 5.

FIG. 3 additionally shows the structural component 11, which is separated from the panel 2 by a distance determined by the respective overall structure, it being necessary for said distance to be taken into consideration and maintained when attaching the securing device.

FIG. 4 shows the structural component according to FIGS. 1 and 2 together with the panel 2 and the structural component 11 in a position in which, in comparison with the position of proximity shown in FIG. 3, the securing device has now been screwed into the panel 2 to such an extent that the sleeve 4 contacts the structural component 11 with its obliquely extending parts 8.

When the tubular piece 1 is now screwed further into the panel 2, there finally result the relative positions of tubular piece 1 and panel 2 as shown in FIG. 5, in which positions, while maintaining the distance between panel 2 and structural component 11, the end of the tubular piece 1 facing away from the flange 5 comes into contact with the structural component 11. In this thus adjusted position of the tubular piece 1, the sleeve 4 has been displaced in the tubular piece 1 to such an extent that, as shown in FIG. 5, the outside of the collar 6 of the sleeve 4 is flush with the surface of the flange 5 and is therefore outwardly clearly visible. Thus displaced into its backward position, the sleeve consequently indicates to the assembler that the tubular piece 1 has now been screwed into the panel 2 just so far that its end facing away from the flange 5 is in contact with the structural component 11, this meaning that the final position of the tubular piece 1 has been found, said final position therefore also being maintained.

The above-described displacement of the sleeve 4 can also be used to ensure that a sensor on an assembly tool detects that the collar 6 has reached the position shown in FIG. 5. For this purpose, the assembly tool has a hexagonal chuck which is consistent with the hexagonal design of the collar 5 as shown in FIG. 2 and is therefore able securely to screw in the tubular piece 1. The assembly tool is provided in known manner with a corresponding sensor which responds when the position of the collar 6 shown in FIG. 5 is reached and thus indicates the end of the screwing-in operation.

If, for whatever reason, the tubular piece 1 is again unscrewed out of the panel 2, then, on account of the action of the oblique surfaces 8 and the sloping faces 9 presented in connection with FIG. 1, the sleeve 4 is displaced back into its starting position shown in FIG. 4, which means, therefore, that the securing device can also be screwed on and unscrewed a number of times, the sleeve 5 being able each time to be moved back and forth into its starting position according to FIG. 4 and its backward position in FIG. 5.

With the securing device in the position shown in FIG. 5, it is now possible by means of the screw 12 to achieve a secure connection between the panel 2 and the structural component 11, the screw 12 being supported with its collar on the tubular piece 1. By means of the nut 14 the structural component 11 is then locked in position in relation to the tubular piece 1, it being ensured by the tubular piece 1 screwed into the panel 2 that, on account of the tightened screw 12, there is no change in the distance between the panel 2 and the structural component 11, i.e. the structural component 11 is now clearly secured to the panel 2 at a defined previously existing distance.

FIG. 7 shows a variant of the distance detector, which is in this case in the form of the pin 15. The pin 15 is let into a longitudinal hole 16 in the tubular piece 1 and projects on its side facing away from the flange S in the same manner as described in FIG. 1 in connection with the oblique surfaces 8. The pin 15 is able to be axially displaced when it makes contact with a structural component 11, whereupon on the upper side of the flange 5 it reaches a position in which, on the one hand, it is easily visible and in which, on the other hand, if required, it actuates a sensor, as described in connection with FIG. 5.

The pin 15 may also be held in its starting position shown in FIG. 7 by a spring element, which may, for example, consist in that, on its side facing away from the flange 5, the pin 15 comprises oblique surfaces which are supported against corresponding sloping faces in the longitudinal hole 16.

FIG. 8 shows a top view of the securing device according to FIG. 7, it being possible to discern the longitudinal hole 16 in which the pin 15 is guided.

What is claimed is:

1. Securing device for a structural component (11) to be secured to a panel (2) with a tubular piece (1) inserted into a penetration (17) in the panel (2), into which tubular piece (1) is inserted a screw (12), said screw (12) being supported with its head (13) on the one end of the tubular piece (1) and holding the structural component (11) with its threaded part, said structural component (11) contacting the other end of the tubular piece (1), said tubular piece (1) being screwed an optional distance into the penetration (17) for axial adjustment, characterized in that the tubular piece (1) contains a distance detector (4, 15), wherein, when the tubular piece (1) is at a distance from the structural component (11), said distance detector (4, 15) is in its starting position projecting out of said tubular piece (1) on its side facing away from the screw head (13) and, when the tubular piece (1) is in contact with the structural component (11), said distance detector (4, 15) is noticeably displaced out of the tubular piece (1).

2. Securing device according to claim 1, characterized in that the distance detector is in the form of a sleeve (4) inserted into the tubular piece (1).

3. Securing device according to claim 2, characterized in that the sleeve (4) is slotted.

4. Securing device according to claim 1, characterized in that the distance detector is in the form of a pin (15) axially guided in the tubular piece (1).

5. Securing device according to any one of claims 1 to 4, characterized in that the distance detector (4, 15) is forced into its starting position by a spring element (8).

6. Securing device according to claim 5, characterized in that the spring element consists of oblique surfaces (9) disposed on the sleeve (4) on its side facing away from the screw head (13), said oblique surfaces (9) cooperating with sloping faces (8) at the relevant end of the tubular piece (1).
